(19) United States
(12) Patent Application Publication
(10) Pub. No.: US 2012/0070108 A1
(43) Pub. Date: Mar. 22, 2012

(54) HYDROSTATIC ARRANGEMENT FOR A SPIN WELDING MACHINE AND METHOD OF SUPPORTING SPINDLE FOR THE SAME

(76) Inventor: Leonid Kashchenevsky, Plainville, CT (US)

(21) Appl. No.: 13/234,732

(22) Filed: Sep. 16, 2011

Related U.S. Application Data
(60) Provisional application No. 61/383,977, filed on Sep. 17, 2010.

(51) Int. Cl. F16C 32/06

(52) U.S. Cl. 384/107

(57) ABSTRACT

A hydrostatic arrangement for a spin welding machine includes, a spindle rotationally supported with at least one of a thrust hydrostatic bearing and a journal hydrostatic bearing, and a hydraulic unit configured to supply liquid to the at least one of a thrust hydrostatic bearing and a journal hydrostatic bearing at at least two different pressures.

### CROSS REFERENCE TO RELATED APPLICATION

This application claims priority to U.S. provisional application, 61/383,977, filed Sep. 17, 2010, the entire contents of which are incorporated herein by reference.

### BACKGROUND

Friction welding is one of the most advanced welding processes. It provides strong and reliable connection between welded parts and can be used to join together parts made of different materials. Friction welding is used in a wide variety of applications including many in the aviation and automotive industries.

One method of friction welding is “spin welding.” Spin welding is used to weld round parts together. Spin welding systems contain two chucks with parts to be welded clamped into each of the two chucks. One of the chucks rotates while the other remains stationary. The parts are forced together with axial force that generates high friction and high temperatures resulting in end portions of the parts melting during the welding process.

Because high speeds and extremely high forces are simultaneously required, the rotating shaft bearings have to satisfy very challenging and conflicting requirements: they have to endure high loads while at the same time be able to rotate at high speed. Reducing load capacity of the bearing will allow higher speeds but will lead to excessive wear. Inversely, bearings with increased load capacity can withstand high forces but will generally require higher torques, and consequently consume more energy and generate excessive heat.

### BRIEF DESCRIPTION

Disclosed herein is a hydrostatic arrangement for a spin welding machine. The arrangement includes, a spindle rotationally supported with at least one of a thrust hydrostatic bearing and a journal hydrostatic bearing, and a hydraulic unit configured to supply liquid to the at least one of a thrust hydrostatic bearing and a journal hydrostatic bearing at at least two different pressures.

Further disclosed herein is a method of supporting a spindle in a spin welding machine. The method includes, supporting the spindle with at least one of a thrust hydrostatic bearing and a journal hydrostatic bearing, supplying liquid at a first pressure to the at least one of a thrust hydrostatic bearing and a journal hydrostatic bearing when the spindle is rotating and the spin welding machine is not actively spin welding, and supplying liquid at a second pressure to the at least one of a thrust hydrostatic bearing and a journal hydrostatic bearing when the spindle is rotating and the spin welding machine is actively spin welding.

### BRIEF DESCRIPTION OF THE DRAWINGS

The following descriptions should not be considered limiting in any way. With reference to the accompanying drawings, like elements are numbered alike:

FIG. 1 depicts a schematic view of a spin welding machine disclosed herein employing multiple pumps;

FIG. 2 depicts a schematic view of a spin welding machine disclosed herein employing a single pump that supplies different pressures via operating at different speeds;

FIG. 3 depicts a schematic view of a spin welding machine disclosed herein employing a single pump and a hydraulic accumulator;

FIG. 4A depicts a schematic view of a portion of a hydrostatic spindle of a spin welding machine disclosed herein that includes a recess to compensate for shaft weight; and

FIG. 4B depicts a partial cross sectional view of the hydrostatic spindle of FIG. 4A taken through the recess at arrows 4-4.

### DETAILED DESCRIPTION

A detailed description of one or more embodiments of the disclosed apparatus and method are presented herein by way of exemplification and not limitation with reference to the Figures.

The current invention uses hydrostatic bearings to support a rotating shaft instead of the typical ball (or roller) bearings that are commonly employed in heavy-duty spin welding machines.

Increasing bearing fluid supply pressure can increase stiffness and load capacities of hydrostatic bearings without changing bearing sizes. In most current applications of hydrostatic bearings, however, the maximum supply pressure is limited by needed increases in flow rates and by increases in power required to pump fluid through the bearings. The pump power increases faster than the flow requirements, as it is proportional to the square of the supplied pressure.

Consequently an increased flow will typically require larger and more expensive components for the hydraulic power unit. Additionally, higher flow rates typically result in increased fluid leakage (i.e. along a spindle, for example). Ways of reducing flow at higher supply pressures include, increasing the surface area of gaps, reducing the size of gaps, and increasing viscosity of the fluid, typically oil, or combinations thereof. Everything that reduces flow, however, will also increase friction. In fact, hydrostatic bearings have similar issues as ball bearings regarding tradeoffs between speed and load capacity.

The methods disclosed herein, however, resolve this fundamental tradeoff in a simple and reliable way. A spin welding process consists of two main phases: Phase 1—when a shaft and a part clamped in a chuck are accelerated to the required speed (usually with a flywheel fixedly attached to the shaft to supply inertia to the system); and Phase 2—when a non-rotating part is pushed against the rotating part with high axial force to generate the welding conditions.

In comparison, a duration of phase 2 is typically much less than a duration of Phase 1. Phase 2 typically only lasts a few seconds.

During Phase 1, forces applied to the bearings are relatively low in comparison to the forces applied during Phase 2. During Phase 1 bearings only have to support radial forces caused by weight of the shaft (including the chuck the flywheel and the part), and axial forces are negligible. Consequently, during Phase 1 the supply pressure can be relatively low while the bearing has large gaps and small surface areas without requiring excessively high flow rates. The large gaps and small surface areas allow for low friction in the bearings and will allow relatively high rotational speeds. This means that bearings with relatively low stiffness can be used for Phase 1

During Phase 2, however, pressure needs to be increased significantly to withstand the welding forces. This high-pressure condition, however, is only needed long enough to avoid leakage problems and results in little if any increase in the average energy consumption. Consequently, Phase 2 requires bearings that have stiffness many times more than those used in Phase 1.

By simply changing the inlet pressure both stiffness and load capacity of hydrostatic bearings can be changed (and almost instantly). Hydrostatic bearings designed for low pressure applications have lower friction losses compared with bearings designed for high pressure applications because larger gaps and lower viscosity oil can be used to keep the same flow and the same pumping power.

Hydrostatic bearings designed for low inlet pressure applications cannot be used permanently with significantly increased inlet pressures, however, because doing so would require higher flow rates and greater pumping power. During short periods of time, however, an inlet pressure increase is acceptable. This short duration has a relatively small impact on an average pumping power needed, while not provided sufficient time to cause significant leakage from the spindle.

A significant benefit of hydrostatic bearings is their wear free performance. Hydrostatic bearings can last indefinitely without change to their performance characteristics. Monitoring performance and performing bearing system maintenance for hydrostatic bearings is also a simple undertaking.

Hydrostatic bearings also permit at least a few different ways to switch instantly from one inlet pressure to another, a few of which are described below.

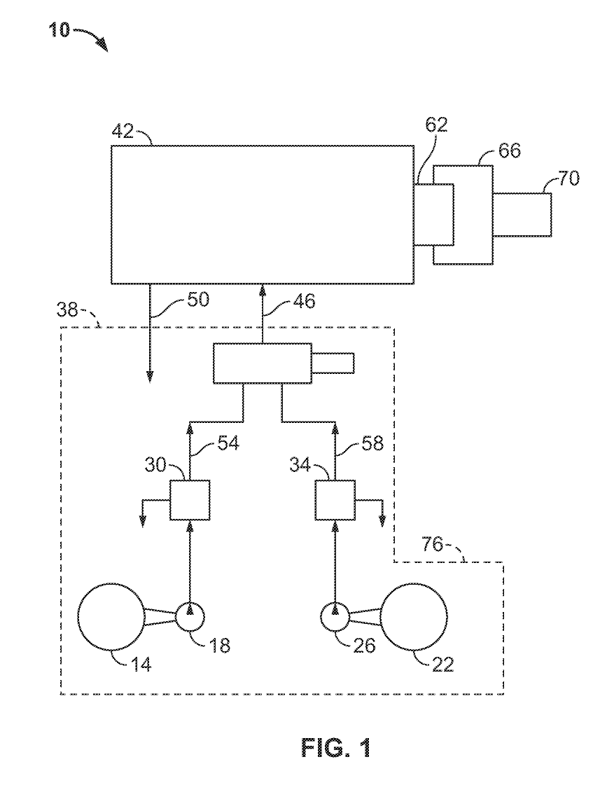

Referring to FIG. 1, a spin welding machine disclosed herein is illustrated at 10. The spin welding machine 10 includes, two pumps 18 and 26, and two motors 14 and 22. In this embodiment, the pump 18 has a lower flow rate than the pump 26 and is driven by the motor 14 that has less power than the motor 22. Oil from the pump 18 flows through a pressure relief valve 30 adjusted to a first pressure, while oil from the second pump 26 flows to a pressure relief valve 34 adjusted to a second pressure. The first pressure is lower than the second pressure. A control valve 38 connects to a spindle inlet line 46 to allow flow thereto from either the pressure relief valve 30, via low-pressure line 54, or from the pressure relief valve 34, via high-pressure line 58. Spindle 42 has a rotating chuck 66 mounted on a shaft 62 with a part to be welded 70 clamped into the chuck 66. A return line 50 ports return fluid to a hydraulic power unit 76. Switching of the control valve 38 will alter supply to the spindle 42 between high-pressure oil and low-pressure oil.

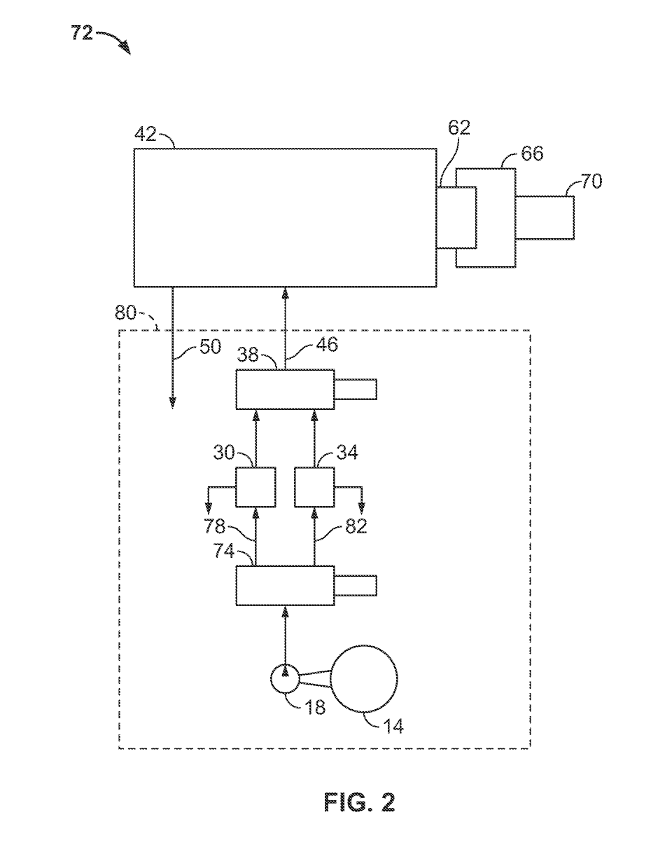

Referring to FIG. 2, a second embodiment of a spin welding machine is illustrated at 72. The spin welding machine 72, as in machine 10, includes the motor 14 that drives the pump 18. The motor 14 is controllable between high speed and low speed. When the motor 14 is running at low speed, flow provided by the pump 18 will be lower than flow provide by the pump 18 when the motor 14 is running at high speed. Flow output from the pump 18 will vary substantially proportionally with the speed of the motor 14. A control valve 74 is configured to switch the flow from the pump 18 between a low-pressure line 78 and a high-pressure line 82. When the motor 14 is operated at low speed, flow is directed to the low-pressure line 78 and to the pressure relief valve 30 adjusted for lower pressure. When the motor 14 is operated at high speed the flow is directed to the high-pressure line 82 and to the pressure relief valve 34 that is adjusted to a higher pressure setting than that of the pressure relief valve 30. The control valve 38 connects the spindle inlet line 46 to low-pressure low flow or high-pressure high flow in the same way as it does in the first embodiment. Additionally, the return line 50 ports return fluid to a hydraulic power unit 80.

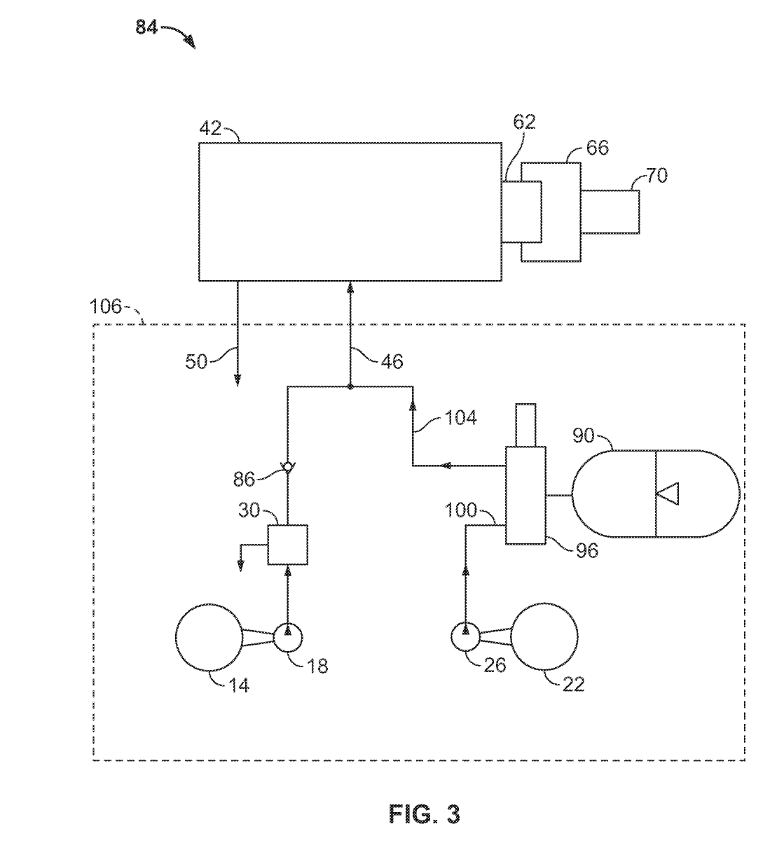

Referring to FIG. 3, an alternate embodiment of a spin welding machine is illustrated at 84. The motor 14 drives the pump 18 that pumps oil to the spindle inlet 46 during the acceleration phase (Phase 1) of the welding cycle. The pressure relief valve 30 is adjusted to a low pressure sufficient for Phase 1 when external loads on the spindle 42 are relatively low. The motor 22 drives the pump 26 that pumps oil to charge a rather large hydraulic accumulator 90 through a line 100 and control valve 96. In Phase 2, when loads on the spindle 42 are high, the control valve 96 is set to supply oil at high pressure and high flow to the spindle 42 from the accumulator 90 via lines 104 and 46. A check valve 86 prevents oil under high-pressure from flowing backwards through the relief valve 30 to the pump 18. The accumulator 90 can provide very high flow rates with a relatively high constant pressure for short periods of time. As such, the accumulator 90 is well suited for the short amount of time the machine 84 operates at high pressure and at high flow conditions. Additionally, in this embodiment, as with the previous embodiments, the return line 50 ports return fluid to a hydraulic power unit 106.

It should be noted that some components of the spin welding machines 10, 72 and 84 are not represented in the hydraulic schematic diagrams of FIGS. 1-3, such as, filters, pressure gages and hydraulic tanks, for example, in order to simplify the description. One skilled in the art will understand that such components, though important, need not be shown to adequately describe how the machines are built and operated.

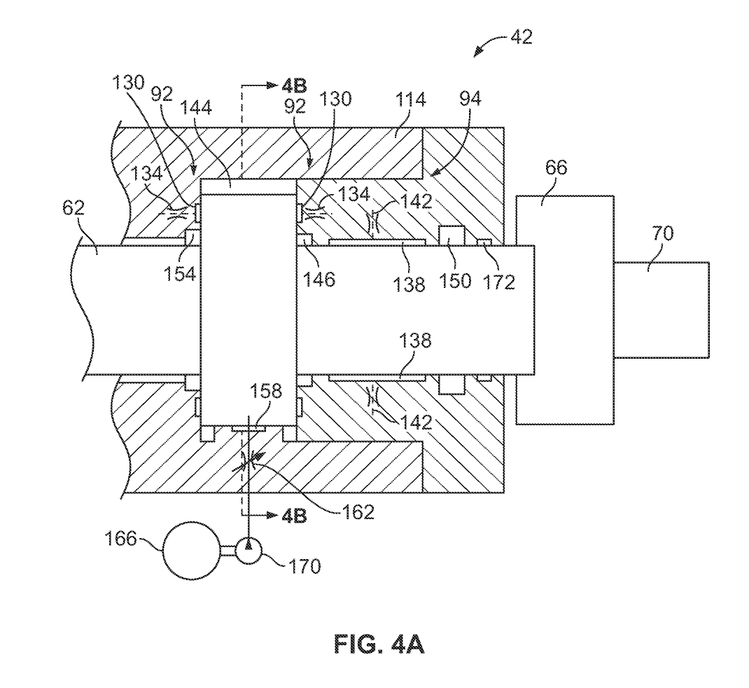

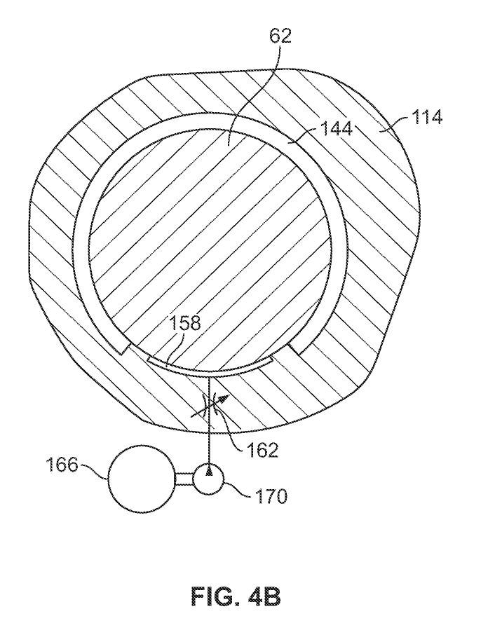

Referring to FIGS. 4A and 4B, an embodiment of the spindle 42, usable in any of the machines 10, 72 and 84, is disclosed and described in greater detail. The spindle 42 has features that allow an additional reduction in supply pressure during Phase 1, to further reduce friction and increase the maximum rotational speed of the shaft 62. The rotating shaft 62 is supported by thrust hydrostatic bearings 92 and journal hydrostatic bearings 94 relative to a non-moving housing 114. The chuck 66 is mounted on the shaft 62 and the part 70 to be welded is clamped into the chuck 66. In axial directions the shaft 62 is supported by the thrust hydrostatic bearing 92 with annular recesses 130 and with inlet restrictors 134. Hydraulic oil is supplied at high pressure to the recesses 130 from one of the external hydraulic power units 76, 80 or 106 through inlet restrictors 134. In radial directions the shaft 62 is supported by at least two journal hydrostatic bearings 94 with a selected number of recesses 138. Only the journal hydrostatic bearing 94 nearest the chuck 66 is shown in FIG. 4A. Oil is supplied through inlet restrictors 142 to the journal bearing recesses 138. From thrust recesses 130, oil flows to chambers 144, 154 and 146 connected directly to the return line 50 (FIGS. 1-3). From journal recesses 142, oil flows to return chambers 146 and 150 and then on to the return line 50. Annular groove 172 is connected to a supply of pressurized air and is used for air sealing to prevent oil leakage along the spindle 42 to an outside of the machine 10, 72, 84. A separate recess 158 is located on a bottom-side of the annular chamber 144. Oil is supplied to the recess 158 through an adjustable flow-regulating valve 162 from a pump 170 driven by a motor 166. The recess 158 compensates, at least partly, for the static component of radial load on the shaft 62 resulting from the weight of the shaft 62 as well as the weight of other components mounted to the shaft 62 such as the chuck 66 and a flywheel (not shown). FIG. 4B shows a cross sectional view of the shaft 62, part of the housing 114, the chamber 144 and the recess 158 taken at arrows 4-4 of FIG. 4A.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A hydrostatic arrangement for a spin welding machine comprising:
a spindle rotationally supported with at least one of a thrust hydrostatic bearing and a journal hydrostatic bearing; and
a hydraulic unit configured to supply liquid to the at least one of a thrust hydrostatic bearing and a journal hydrostatic bearing at at least two different pressures.

2. The hydrostatic arrangement for a spin welding machine of claim 1, wherein the liquid is oil.

3. The hydrostatic arrangement for a spin welding machine of claim 1, wherein the hydraulic unit is configured to supply liquid at a first pressure when the spin welding machine is not actively spin welding and at a second pressure when the spin welding machine is actively spin welding.

4. The hydrostatic arrangement for a spin welding machine of claim 1, wherein the first pressure is less than the second pressure.

5. The hydrostatic arrangement for a spin welding machine of claim 1, wherein the hydraulic unit includes at least two pressure relief valves with at least two of the at least two pressure relief valves being configured to limit pressure of the liquid supplied to the at least two different pressures.

6. The hydrostatic arrangement for a spin welding machine of claim 5, further comprising a control valve configured to control which one of the at least two pressure relief valves supplies the pressurized liquid.

7. The hydrostatic arrangement for a spin welding machine of claim 5, wherein each of the at least two pressure relief valves is configured to control pressure in a line from a pump.

8. The hydrostatic arrangement for a spin welding machine of claim 7, further comprising a motor configured to operate at various speeds being in operable communication with the pump.

9. The hydrostatic arrangement for a spin welding machine of claim 1, wherein the hydraulic unit includes at least two pumps having different pumping characteristics from one another.

10. The hydrostatic arrangement for a spin welding machine of claim 9, further comprising two motors each being in operable communication with one of the at least two pumps and having different power characteristics from one another.

11. The hydrostatic arrangement for a spin welding machine of claim 1, wherein the hydraulic unit includes:
a first pump
a pressure relief valve configured to limit liquid supplied from the first pump to a first pressure;
a second pump;
a hydraulic accumulator fillable with fluid supplied by the second pump to a second pressure; and
a control valve configured to control which of the hydraulic accumulator and the pressure relief valve supplies pressurized liquid to the at least one of a thrust hydrostatic bearing and a journal hydrostatic bearing.

12. The hydrostatic arrangement for a spin welding machine of claim 11, further comprising a check valve configured to prevent liquid from the hydraulic accumulator from flowing back to through the first pump.

13. The hydrostatic arrangement for a spin welding machine of claim 1, wherein the at least one journal hydrostatic bearing includes a recess configured to compensate for static weight forces of at least the spindle.

14. The hydrostatic arrangement for a spin welding machine of claim 1, wherein the spindle is rotationally supported by both a thrust hydrostatic bearing and a journal hydrostatic bearing and both are supplied liquid at the at least two different pressures from the hydraulic unit.

15. A method of supporting a spindle in a spin welding machine, comprising:
supporting the spindle with at least one of a thrust hydrostatic bearing and a journal hydrostatic bearing;
supplying liquid at a first pressure to the at least one of a thrust hydrostatic bearing and a journal hydrostatic bearing when the spindle is rotating and the spin welding machine is not actively spin welding; and
supplying liquid at a second pressure to the at least one of a thrust hydrostatic bearing and a journal hydrostatic bearing when the spindle is rotating and the spin welding machine is actively spin welding, the second pressure being greater than the first pressure.

16. The method of supporting a spindle in a spin welding machine of claim 15, further comprising:
setting the first pressure with a first pressure relief valve; and
setting the second pressure with a second pressure relief valve.

17. The method of supporting a spindle in a spin welding machine of claim 15, further comprising:
pumping liquid to the first pressure with a first pump; and
pumping liquid to the second pressure with a second pump.

18. The method of supporting a spindle in a spin welding machine of claim 17, further comprising storing liquid pumped from the second pump in a hydraulic accumulator.

19. The method of supporting a spindle in a spin welding machine of claim 18, wherein the supplying liquid at the second pressure is from the hydraulic accumulator.

20. The method of supporting a spindle in a spin welding machine of claim 15, further comprising altering between supplying liquid at the first pressure and the second pressure with a control valve.

21. The method of supporting a spindle in a spin welding machine of claim 15, further comprising altering between supplying liquid at the first pressure and the second pressure with a variable speed motor driven pump.
